(19) United States
(12) Patent Application Publication
(10) Pub. No.: US 2009/0315886 A1
(43) Pub. Date: Dec. 24, 2009

(54) METHOD TO PREVENT RESOURCE EXHAUSTION WHILE PERFORMING VIDEO RENDERING

(75) Inventors: Marine Drive, Bangalore (IN); Subramanya J. NarayanaMurthy, Bangalore (IN); Rajeshkumar Thappali Ramaswamy Sethuraman, Madurai (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/142,364

(22) Filed: Jun. 19, 2008

(51) Int. Cl. G06F 17/00

(52) U.S. Cl. 345/428; 345/418

(57) ABSTRACT

The inventive system and method for preventing resource exhaustion while performing video rendering comprises calibrating resource utilization of operating parameters, obtaining input configuration comprising a priority order and source data, and controlling streaming and rendering frame rates by dropping data based on the input configuration. The operating parameters can comprise CPU, RAM, and GC usage. The source data can be resource utilization, a database and an application service. Dropping data can be performed using a throttling mechanism. In one embodiment, calibrating further comprises determining resource utilization using an input resolution and streaming at 1 FPS, determining resource utilization using the input resolution and streaming at 30 FPS, calculating an output resolution, if the output resolution does not exceed the input resolution, getting another input resolution, and determining resource utilization and calculating another output resolution, and determining resource utilization and calculating output resolution with rendering on.

### FIELD OF THE INVENTION

This invention relates generally to video rendering. In particular, this invention relates to a method for robustly performing system configuration to prevent resource exhausting for video rendering using business rules-based proportional data dropping.

### BACKGROUND OF THE INVENTION

The number of hardware and software configurations in a computer system is virtually unlimited, the specifications of the system being decided by customer requirements, both present and future. When video rendering is a desired activity, proper precautions regarding system configuration must be taken, as video rendering is a resource intensive activity. The components or resources related to video rendering can include RAM size, graphic card (GC) capacity, processor (CPU) capacity, and so on. The complexity of the video rendering problem is compounded by the availability of various encoding and decoding techniques to meet specific needs of the customers. The CPU utilization in this context also depends on the decoder being used, such as MJPEG (Moving JPEG), MPEG4, and H.264, resolution being handled (QCIF to any Mega Pixels), frames per second, and the type of post filters being used, such as de-interlaced, changing brightness, etc.

A procedure or application that will robustly perform video rendering in varying combinations of system configurations is a clear need. The robust application must not underutilize the “horse power” of the computer system. Saturation of computer system resources, resulting in an application hang or slow down, must also be prevented. Further it is important to avoid interfering with, e.g., slowing down, other applications running in the computer system.

### SUMMARY OF THE INVENTION

The present invention advantageously provides a novel system and method for preventing resource exhaustion while performing video rendering. Business rules-based proportional data drop can be employed. The desired resources are determined and appropriate data is dropped in accordance with this resource determination. The invention does not require any specific encoder/decoder pair, but optimizes the resource utilization of any given encoder/decoder pair on a rendering workstation or computer. This includes any custom or proprietary encoder/decoder pair that might be used to code and decode the video. Based on the baseline resource utilization of the encoder/decoder pair, the system can choose the priority logic by which the system will determine which data is more important than the other. An inventive application is presented that runs on a variety of computer hardware without locking down or hanging the system or processor, and that provides a way to share resources with other services and/or applications running on the same computer.

The inventive system and method for preventing resource exhaustion while performing video rendering comprises calibrating resource utilization, said resource comprising operating parameters, obtaining input configuration comprising an order of priority and data from a source, and controlling streaming and rendering frame rates by dropping data based on the input configuration. The operating parameters can comprise a percent of CPU, an amount of RAM, and GC usage. The source can be calibrated resource utilization, a database and an application service. Dropping data can be performed using a throttling mechanism. In one embodiment, calibrating further comprises a) turning off rendering and getting a first input resolution, b) replacing an input resolution with the first input resolution, c) determining the resource utilization using the input resolution and streaming at 1 FPS, d) determining the resource utilization using the input resolution and streaming at 30 FPS, and calculating an output resolution, e) if the output resolution does not exceed the input resolution, getting a next input resolution, replacing the input resolution with the next input resolution, and performing steps c), d) and e), and f) if the output resolution exceeds the input resolution and the rendering is off, turning on the rendering, replacing the input resolution with the first input resolution and performing steps c), d) and e).

### BRIEF DESCRIPTION OF THE DRAWING

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a schematic illustration of an exemplary embodiment of the present invention;

FIG. 2 is a flow diagram of phases of an exemplary embodiment of the present invention;

FIG. 3 is a flow diagram of an analysis phase of the present invention;

FIG. 4 is a flow diagram of an input configuration phase of the present invention; and

FIG. 5 is a flow diagram of an output control phase of the present invention.

The foregoing and other objects, aspects, features, advantages of the invention will become more apparent from the following description and from the claims.

### DISCLOSURE OF THE INVENTION

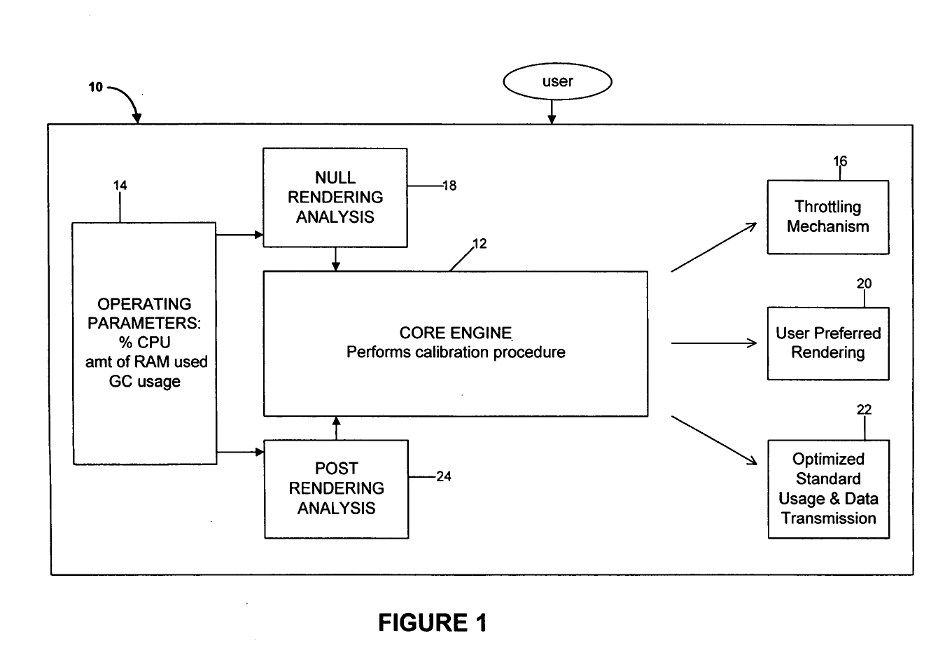

An exemplary system 10 for robustly performing system configuration and preventing resource exhaustion for video rendering is shown in FIG. 1. System 10 is the reference to the complete end-user application installed in the premises. The system 10 consists of various applications required to perform designed tasks. In an exemplary embodiment, for example, the database application will be used to read and store values/data into the database, the rendering application will be used to render video on the user workstations, the server application will be used to manage the user connecting to the system, the calibration application will be used to compute the calibration, and so on.

The inventive system and method employs an internal system calibration procedure within a core engine 12 to determine an appropriate configuration for system resources 14, e.g. CPU, RAM, GC, to be used for video rendering, and then to decide what data to drop during rendering, so that data is dropped intelligently. Dropped data could be reduction in resolution, number of frames that are rendered, and, in a few cases, number of frames transmitted from the server. A throttling mechanism 16 can be used to achieve automatic data dropping. This mechanism 16 maintains the operating condition of the system; for example, when more computer system resources 14 are available, less data dropping is required and vice versa. Business rule-based proportional data dropping techniques can be employed by the throttling mechanism 16.

The internal calibration procedure performed in the core engine 12 includes an analysis phase and an input methodology from which a sequence of steps in the form of an algorithm is created. In the analysis phase, the core engine 12 calibrates total number of frames versus resolution versus decoder for the given operating parameters. The resource utilization of the encoder/decoder pair in a workstation of any configuration is ascertained. The encoder/decoder pairs can include a large range of encoders and decoders, such as IP cameras, network based cameras, digital video recorders (DVR) and network video recorders (NRV). Other encoders and decoders can also be used. The input methodology determines what resources 14 should be used on the specified workstation or computer, with CPU utilization as the core metric. In accordance with the determined configuration of these resources 14, the sequence of steps required to prevent the rendering software application from using more than the allocated resources in the workstation is then established.

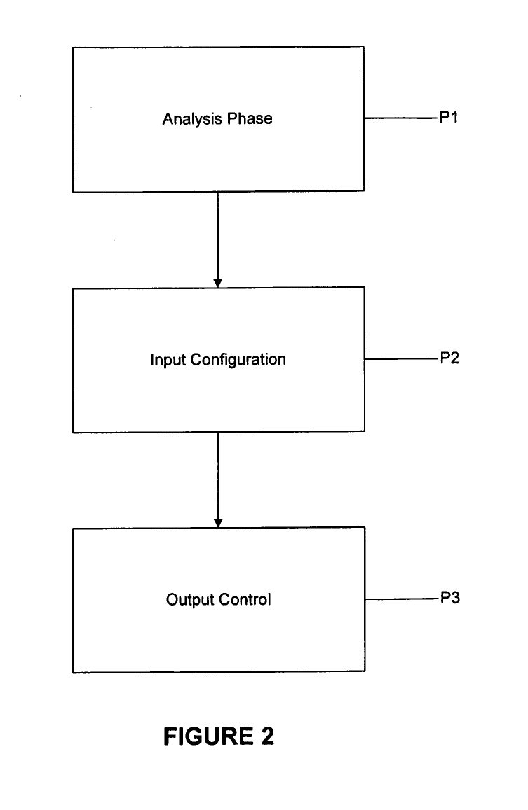

The processes that make up the inventive system and method are shown in FIG. 2 and described in more detail below. The first process P1 is an analysis phase and the second process P2 is an input configuration phase P2. Phases P1 and P2 are performed as the internal calibration procedure in the core engine 12. The third process is an output control phase P3.

A base performance can be calculated by streaming video from the particular encoder/decoder device or pair at a designated frame rate and resolution, e.g., one (1) frame per second (FPS) and same input resolution initially, and the resources 14 needed by the rendering software application are tracked. Then the internal calibration procedure starts rendering, i.e., decoding and displaying, at a higher frame rate, observing the resource usage 14. At this point, the core engine 12 will be able to determine the usage of resources 14 for various combinations of resolution and frame rate. For example, the calibration procedure internally calibrates an approximate total number of frames, resolution, and decoder that will place a load of seventy per cent or less on the processor, that is, it will calibrate a load the processor can handle.

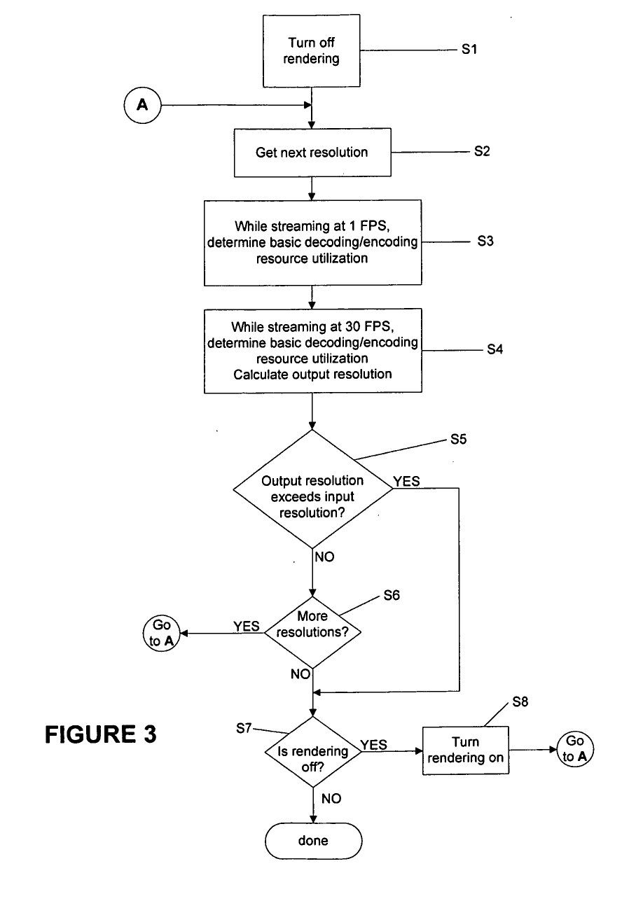

The steps of the analysis phase P1 are shown in FIG. 3 in accordance with the system 10 shown in FIG. 1. The specified encoder/decoder pair for which the resource usage 14, including the CPU, RAM and Graphic Card usage, is to be determined is activated. To establish the basic decoding/encoding resource utilization, the streaming can be performed without rendering onto the workstation, so initially, in step S1, rendering is turned off, or null rendering analysis 18 is performed. Decoder operating parameters, e.g., CPU, RAM, GC, are analyzed without post filtering and rendering on a given standard setting by performing steps S2 through S6 as follows.

An input resolution is obtained in step S2. In step S3, a streaming of 1 FPS is initiated. Then, in step S4 streaming is raised up to thirty (30) FPS, either by increasing frame rate or by replicating the same session onto multiple sessions, and the core engine 12 calibrates standard settings including resolution and frame rate—filtering. The output of step S4 determines the base performance of the encoder/decoder pair for a given resolution. Output resolution is determined in accordance with the client application layout that can have several sized display salvo controls, ranging to display several resolutions, based on the user selection. Hence, the salvo layout establishes the output resolution. The results of the core engine calibration 12 can be used by the throttling mechanism 16 when determining automatic data dropping, discussed above, user preferred rendering 20, and optimized standard usage and data transmission 22.

Because the decoder (output) resolution cannot exceed encoding (input) resolution, the output resolution is compared to the input resolution in step S5. If the output resolution is less than the input resolution (S5=NO), the existence of another resolution is determined in step S6. If there is another resolution (S6=YES), processing returns to step S2 where another input resolution is obtained. The processing continues with this new input resolution as described above at step S3 and beyond. Resolutions can include QCIF, CIF, 2CIF, 4CIF, D1, 1M, 2M, and can be any Mega Pixel.

If there are no other resolutions (S6=NO), the status of the rendering is checked in step S7. If the rendering is off (S7=YES), then it is turned on, or post rendering analysis 26 is initiated, in step S8. Decoder operating parameters, e.g., CPU, RAM, GC, are now analyzed for current rendering operation values, determining the effects of filters and fine tuning standard setting by again performing steps S2 through S6 as described above.

If the analysis has been performed with post rendering analysis 26 (S7=NO), the analysis process of the calibration procedure is complete. A conclusive way to determine the decoding and rendering efficiency on a given workstation is obtained when the process is performed using post rendering analysis 24, or rendering ON.

If the output resolution exceeds the input resolution (S5=YES), then the picture or output image starts deteriorating. However, the calibration procedure will not terminate. Instead, the processing will continue at step S7 as described above.

All of the analysis is initially stored in memory of the core engine 12. After the analysis is completed, the analysis gets stored in a configuration file, which could be a text-based file or XML-based file.

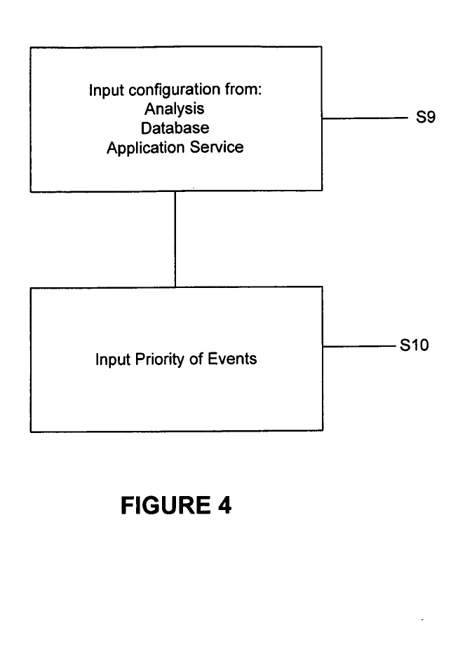

After the analysis phase P1, the input configuration phase P2 can commence. FIG. 4 shows the steps of an exemplary embodiment of this phase. In step S9, a configured CPU usage limitation is input. The input is received from a source, such as a user defined configuration file in which the analysis is stored, as described above. In the alternative, the CPU usage limitation can be obtained from a source such as a database, that is, a primary file in which all application configurations are stored. In another alternative, an application service can be the source of the required input data. An application service is a part of the system software that can provide the calibration values to the core engine to perform throttling. Unlike a run time computation of resource usage discussed above, these calibration values will compute at design time and will pass on the values to the core engine.

In step S10, a priority of events, or order of events in which video is rendered, is input. This priority of events, which is used to define which data is more important than the other, is supplied to the throttling mechanism 16 to assist with deciding which data to drop.

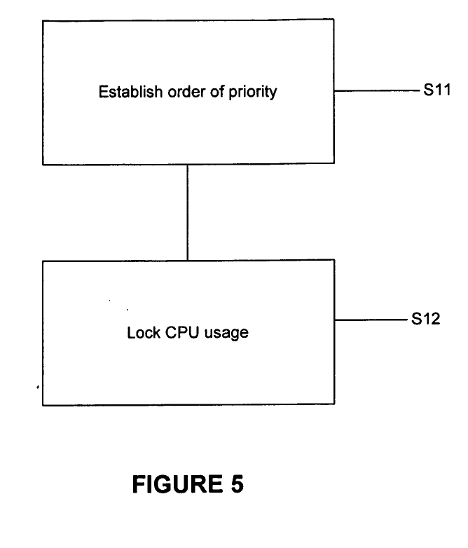

Based on the information obtained in input configuration phase P2, the output control phase P3 is executed so that a specified CPU limit can be established, enabling control of the resource usage 14 in the targeted workstation or computer. FIG. 5 shows the steps of the output control phase P3, in which streaming and rendering frame rates can be controlled using the following steps. In step S11, the priority of events or order of priority is established. This can be done either by retrieving the order of priority from input configuration phase P2, or by obtaining the order of priority from inbuilt default priority logic.

The order of priority of throttling, e.g. use-case, is typically configurable in the system. A series of use-cases can include alarms, alarm priority, automated trigger procedure, manual intervention from the operation and highlighted panel. The default order of priority will most often be user interaction videos followed by automated procedure videos. Thus, any video played as a result of user interaction from an alarm or event in the system has a higher priority, while any video played as a result of an automated procedure during forensics or video verifications purposes has a lower priority. The user interaction videos can be those used in forensics, and live video verification, and can include context menus, double clicks, call up menus, and drag and drops. This default order can be further refined based on whence the video pull-up has originated, so that a higher preference or more significant alarm or event will be given higher priority.

Additional refinements can include manual selection of video panel during regular surveillance, permitting unselected panels to be controlled for both streaming and rendering frame rate. Multiple manual selection priority will be determined by the order in which the user has clicked for selection. Highlighted panel(s) are generally given maximum preference; a highlighted panel is one in which an operator and/or administrator is actively using the panel or means as an alarm response or automatic trigger.

In step S12, a specific CPU usage is fixed or locked, controlling the streaming and rendering frame rates. Because savings of network bandwidth is a result of controlling the streaming frame rates, it will be given preference over controlling the rendering frame rates. In addition, the system assumes a series of use-cases, described above, to determine an automatic data drop to maintain the application so that the resource usage for the system will not be “overshot”.

Upon detecting the overshoot, the system will start performing the operations of step S12 to intelligently drop frames and resolution, thereby reducing the CPU consumption. Generally, within a time range of five to ten seconds, the system stabilizes to the acceptable CPU range, which is anything less than the configured limit. In an exemplary embodiment, the limit is 90%). Also, for a multi processor CPU, the monitoring is performed on all CPU and total CPU usage across all processors should not exceed the configured limit. The inventive system also includes Hyper Threaded (HT) enabled PC which mimics multiple CPU with one physical CPU. The inventive system works on all these variants of computer systems available.

The invention can be implemented as computer software or a computer readable program for operating on a computer. The computer program can be stored on computer readable medium.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method for preventing resource exhaustion while performing video rendering, comprising steps of:
calibrating resource utilization, said resource comprising operating parameters;
obtaining input configuration comprising an order of priority and data from a source; and
controlling streaming and rendering frame rates by dropping data based on the input configuration.

2. The method according to claim 1, wherein the operating parameters comprise a percent of CPU, an amount of RAM, and GC usage.

3. The method according to claim 1, wherein the source is one of the calibrated resource utilization, a database and an application service.

4. The method according to claim 1, wherein dropping data is performed using a throttling mechanism.

5. The method according to claim 1, wherein the step of calibrating further comprises steps of:
a) turning off rendering and getting a first input resolution;
b) replacing an input resolution with the first input resolution;
c) determining the resource utilization using the input resolution and streaming at 1 FPS;
d) determining the resource utilization using the input resolution and streaming at 30 FPS, and calculating an output resolution;
e) if the output resolution does not exceed the input resolution, getting a next input resolution, replacing the input resolution with the next input resolution, and performing steps c), d) and e); and
f) if the output resolution exceeds the input resolution and the rendering is off, turning on the rendering, replacing the input resolution with the first input resolution and performing steps c), d) and e).

6. The method according to claim 1, wherein the order of priority is determined based on the calibrated resource utilization.

7. A computer readable medium having computer readable program for operating on a computer for preventing resource exhaustion while performing video rendering, said program comprising instructions that cause the computer to perform the steps of:
calibrating resource utilization, said resource comprising operating parameters;
obtaining input configuration comprising an order of priority and data from a source; and
controlling streaming and rendering frame rates by dropping data based on the input configuration.

8. The computer program according to claim 7, wherein the operating parameters comprise a percent of CPU, an amount of RAM, and GC usage.

9. The computer program according to claim 7, wherein the source is one of the calibrated resource utilization, a database and an application service.

10. The computer program according to claim 7, wherein dropping data is performed using a throttling mechanism.

11. The computer program according to claim 7, wherein the step of calibrating further comprises steps of:
a) turning off rendering and getting a first input resolution;
b) replacing an input resolution with the first input resolution;
c) determining the resource utilization using the input resolution and streaming at 1 FPS;
d) determining the resource utilization using the input resolution and streaming at 30 FPS, and calculating an output resolution;
e) if the output resolution does not exceed the input resolution, getting a next input resolution, replacing the input resolution with the next input resolution, and performing steps c), d) and e); and
f) if the output resolution exceeds the input resolution and the rendering is off, turning on the rendering, replacing the input resolution with the first input resolution and performing steps c), d) and e).

12. The computer program according to claim 7, wherein the order of priority is determined based on the calibrated resource utilization.
